(19) United States
(12) Patent Application Publication
(10) Pub. No.: US 2025/0001647 A1
(43) Pub. Date: Jan. 2, 2025

(54) RESIN INFUSED PI-SHAPED PREFORM AND JOINTS THEREOF

(71) Applicant: Lockheed Martin Corporation, Bethesda, MD (US)

(72) Inventors: Felix Nhanchau Nguyen, Parker, CO (US); Carl Q. Rousseau, Weatherford, TX (US); Daniel H. Hecht, Fort Worth, TX (US); Robert Warner Koon, Acworth, GA (US); Tracy Bradford Colwell, Denver, CO (US)

(21) Appl. No.: 18/760,812

(22) Filed: Jul. 1, 2024

Related U.S. Application Data
(60) Provisional application No. 63/511,078, filed on Jun. 29, 2023.

(51) Int. Cl. B29B 11/16; B29C 65/00

(52) U.S. Cl. CPC B29B 11/16; B29C 66/43441; B29C 66/721

(57) ABSTRACT

A pi-shaped preform, an assembly including the same, and methods of making the same are disclosed herein. In some embodiments, a pi-shaped preform includes a base component, a pair of axially elongated legs coupled to the base component to define a channel between the axially elongated legs, and wherein the base component and the pair of axially elongated legs each comprises an oriented ply stack, wherein each ply in the oriented ply stack comprises aligned continuous fibers, and wherein at least one ply in the oriented ply stack comprises stitching fibers, wherein the stitching fibers hold together the aligned continuous fibers of the at least one ply.

### CROSS-REFERENCE TO RELATED APPLICATION(S)

This disclosure claims priority to U.S. Provisional Patent Application No. 63/511,078, filed Jun. 29, 2023, and titled “Resin Infused Oriented Dry Fiber Ply Stack Pi-Shape Preform, and Structure Thereof”, the entire disclosure of which is incorporated by reference herein.

### TECHNICAL FIELD

This disclosure relates in general to structural supports that join similar or dissimilar materials, and more particularly to pi-shaped preforms.

### BACKGROUND

Integrated composite structures are recognized as promising materials for reducing aircraft structure weight and manufacturing cost. 3D woven pi-preforms currently provide a baseline method for achieving robust adhesively bonded joints in composite aircraft structures. However, the cost of 3D woven pi-preforms is prohibitive for numerous applications that would benefit from high performance adhesive joints. For example, 3D woven pi-preforms are manufactured by 3D fiber weaving followed by resin film infusion, both 3D weaving and infusion are time-intensive and require extensive manual labor. The fibers may be carbon fibers. Further, assembly of joints using 3D woven pi-preforms can require long lead times due to time-intensive manufacturing of cured joint components and co-bonding processes.

There is a need in the art for lower cost alternative pi-preforms without excessive sacrifice in performance or even improved performance to enable the use of pi-joint assemblies on a broader range of aircraft and ground vehicle designs.

### SUMMARY OF THE DISCLOSURE

A pi-shaped preform, an assembly including the same, and methods of making the same are disclosed herein.

In some embodiments, a pi-shaped preform includes a base component, a pair of axially elongated legs coupled to the base component to define a channel between the axially elongated legs, wherein the base component and the pair of axially elongated legs each comprises an oriented ply stack, wherein each ply in the oriented ply stack comprises aligned continuous fibers, and wherein at least one ply in the oriented ply stack comprises stitching fibers, wherein the stitching fibers hold together the aligned continuous fibers of the at least one ply.

In some embodiments, a pi-joint assembly includes the pi-shaped preform a first joint component coupled to the base component, and a second joint component coupled to an inner surface of the channel between the axially elongated legs.

In some embodiments, a pi-joint assembly includes a base component, a pair of axially elongated legs coupled to the base component to define a channel between the axially elongated legs, a first joint component coupled to the base component, and a second joint component coupled to an inner surface of the channel between the axially elongated legs, wherein the base component, the pair of axially elongated legs, the first joint component and the second joint component each comprises an oriented ply stack, where each ply in the oriented ply stack comprises aligned continuous fibers, and wherein at least one ply in the oriented ply stack comprises stitching fibers, wherein the stitching fibers hold together the aligned continuous fibers of the at least one ply.

In some embodiments, a method of manufacturing a pi-shaped preform includes laying plies in an oriented ply stack for a base component and a pair of axially elongated legs, wherein each ply comprises aligned continuous fibers, shaping each of the oriented ply stacks into the base component and the pair of axially elongated legs, assembling the pair of axially elongated legs to the base component to form the pi-shaped preform, the pi-shaped preform having a channel defined between the axially elongated legs, infusing a resin into the ply stacks, and curing the resin to a desired state of cure after infusion.

In some embodiments, at least one ply in the oriented ply stack comprises stitching fibers, wherein the stitching fibers hold together the aligned continuous fibers of the at least one ply.

In some embodiments a method of manufacturing a pi-joint assembly includes, after infusion of the resin composition to form the pi-shaped preform, the resin composition being in a partially cured state, coupling a first joint component to the base component, and coupling a second joint component to an inner surface of the channel between the axially elongated legs, and curing the pi-joint assembly.

In some embodiments, a method of manufacturing a pi-joint assembly includes laying plies in an oriented ply stack for a base component, a pair of axially elongated legs, a first joint component and a second joint component, wherein each ply comprises of aligned continuous fibers, shaping each of the oriented ply stacks into the base component, the pair of axially elongated legs, the first and second joint component, assembling the pair of axially elongated legs to the base component to form the pi-shaped preform, the pi-shaped preform having a channel defined between the axially elongated legs, coupling the first joint component to the base component, coupling the second joint component to an inner surface of the channel between the axially elongated legs, infusing a resin composition into the oriented ply stack, and curing the pi-joint.

In some embodiments, at least one ply in the oriented ply stack comprises stitching fibers, wherein the stitching fibers hold together the aligned continuous fibers of the at least one ply.

Other technical advantages will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is now made to the following description, taken in conjunction with the accompanying drawings, in which:

FIG. 1 depicts cross-section view of a pi-shaped preform in accordance with some embodiments of the disclosure.

FIG. 2 depicts cross-section view of a pi-shaped preform in accordance with some embodiments of the disclosure.

FIG. 3 depicts cross-section view of a pi-shaped preform in accordance with some embodiments of the disclosure.

FIG. 4 depicts a top-down schematic view of an individual ply of a pi-shaped preform in accordance with some embodiments of the disclosure.

FIG. 5A depicts a side schematic view of a ply stack in accordance with some embodiments of the disclosure.

FIG. 5B depicts a top-down schematic view of a ply stack in accordance with some embodiments of the disclosure.

FIGS. 6A-6C depict top-down schematic views of an individual ply or ply stack in accordance with some embodiments of the disclosure.

FIG. 7 depicts a cross-section view of a pi-shaped joint assembly in accordance with some embodiments of the disclosure.

FIG. 8 depicts a cross-section view of a pi-shaped joint assembly in accordance with some embodiments of the disclosure.

FIG. 9 depicts a cross-section view of a pi-shaped joint assembly in accordance with some embodiments of the disclosure.

FIG. 10 depicts a cross-section view of a pi-shaped joint assembly in accordance with some embodiments of the disclosure.

FIG. 11 depicts a method of manufacturing a pi-shaped preform in accordance with some embodiments of the disclosure.

FIG. 12 depicts a method of manufacturing a pi-shaped joint assembly in accordance with some embodiments of the disclosure.

FIG. 13 depicts a method of manufacturing a pi-shaped joint assembly in accordance with some embodiments of the disclosure.

### DETAILED DESCRIPTION OF THE DISCLOSURE

3D woven pi-preforms are currently used for achieving adhesively bonded joints in composite aircraft structures. The cost of 3D woven pi preforms is prohibitive for a number of applications that would benefit from high performance adhesive joints. To address these and other challenges associated with typical 3D woven pi-preforms, the disclosed embodiments provide a pi-shaped preform that is a low-cost alternative to 3D woven pi-preforms, with minimal to no performance sacrifice or even improved performance. The provided pi-shaped preforms of the present disclosure allow the use of pi-joint configurations on a broader range of applications within composite air and ground vehicle designs.

To facilitate a better understanding of the present disclosure, the following examples of certain embodiments are given. In no way should the following examples be read to limit, or define, the scope of the disclosure. Embodiments of the present disclosure and its advantages may be best understood by referring to the included Figures, where like numbers are used to indicate like and corresponding parts.

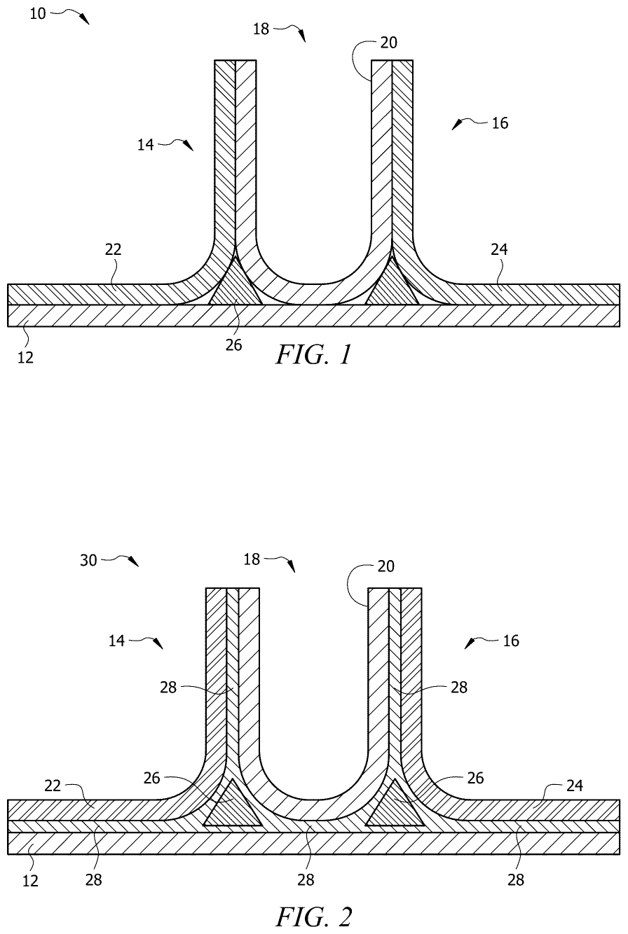

FIGS. 1 through 3 are schematic cross-sectional view of a pi-shaped preformed component or “preform” according to embodiments of the present disclosure. When viewed in cross-section, a preform 10 resembles Greek letter π or “pi” (inverted as shown) having a base component 12 and a pair of axially elongated legs 14, 16 coupled to the base component 12. The pair of axially elongated legs 14, 16 may be perpendicular to the base component 12 or angled. A channel 18 is defined between the axially elongated legs 14, 16. In some embodiments, the pi-shaped preform may include other derivative configurations. Exemplary derivative configurations might be a double “T”, “H” or other complex shapes.

In some embodiments, one or both of the pair of axially elongated legs 14, 16, and the base component 12 may be configured to conform onto surfaces of joint components for an assembly operation as defined herein. Exemplary surfaces of joint components may include a planar, curved, double curved surface or other complex shaped surfaces.

In some embodiments, the pi-shaped preform 10 is a composite material that may be formed by various components. For example, the axially elongated legs 14, 16 may be formed by coupling a U-shaped component 20 to a first L-shaped component 22 and a second L-shaped component 24 positioned opposite the first L-shaped component 22. A filler 26 is positioned in a first space formed between the U-shaped component 20 and the first L-shaped component 22, and the filler 26 is positioned a second space formed between the U-shaped component 20 and the second L-shaped component 24. In some embodiments, the first and second L-shaped components 22, 24 and/or U-shaped component 20 can be tapered proximate the opening of the channel 18 (not shown in FIGS. 1 to 3). The taper may have a smallest thickness of the first and second L-shaped components 22, 24 and/or the U-shaped component 20 at the opening of the channel 18. In some embodiments, a taper may be present at each end of the first and second L-shaped components 22, 24 proximate the base component 12. The taper may decrease in thickness approaching each end.

The filler 26 may include neat resin, adhesive or fiber filled resin, or combinations thereof. The filler 26 primarily fills the spaces formed at the intersection of the U-shaped component 20, first and second L-shaped components 22, 24, and the base component 12. During subsequent processing discussed in the methods of the present disclosure, the filler 26 deforms and flows to fill the spaces. In some embodiments, there are substantially no voids remaining in the spaces after deformation of the filler 26. The filler 26 is utilized in the pi-preform to achieve desired mechanical performance.

In some embodiments, and as depicted in FIG. 1, there is no additional adhesives added between the components of the pi-shaped preform 10. For example, there are no addition adhesives disposed between and coupling: (i) the U-shaped component 20 and the first L-shaped component 22; (ii) the U-shaped component 20 and the second L-shaped component 24; (iii) the first L-shaped component 22 and the base component 12; and (iv) the second L-shaped component 24 and the base component 12.

In some embodiments, and as depicted in a pi-shaped preform 30 of FIG. 2, an adhesive 28 is positioned between the various components to directly or indirectly couple them together. For example, the adhesive 28 may be positioned between: (i) the U-shaped component 20 and the first L-shaped component 22; (ii) the U-shaped component 20 and the second L-shaped component 24; (iii) the first L-shaped component 22 and the base component 12; and (iv) the second L-shaped component 24 and the base component 12 to couple the respective components together. In some embodiments, as depicted in FIG. 2, the adhesive 28 may be continuously disposed between the components. For example, as shown in FIG. 2, there is a continuous path of the adhesive 28 from a top part of the U-shaped component 20 to the right most part of the second L-shaped component 24. In some embodiments (not shown in FIG. 2) the adhesive 28 might be partially disposed between one or more of the U-shaped component 20, the first L-shaped component 22, the second L-shaped component 24, the base component 12 and the fillers 26. For example, the adhesive 28 may be discontinuously disposed between one or more components. For example, individual and separate layers of adhesive 28 may be disposed between the first L-shaped component 22 and the base component 12 and disposed between the second L-shaped component 24 and the base component 12. Exemplary adhesives may include AF6, AF30, AF55, AF 163, and AF191, available from 3M Company, FM 309-1, FM 377, and Meltbond 1515, available from Solvay Chemicals, Inc., EA 7000 and EA 9696, available from Henkel AG & Co., epoxy, bismaleimide and cyanate ester films and pastes, among other adhesives used in the aerospace industry. Similar materials which can be optimized for the environment, mechanical and fabrication requirements of the application can be used as an adhesive in the present disclosure.

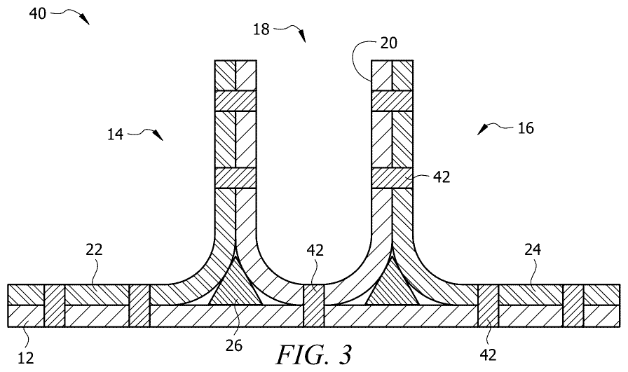

In some embodiments, and as depicted in a pi-shaped preform 40 of FIG. 3, a through-thickness mechanical fastener 42 may couple one or more of: (i) the U-shaped component 20 and the first L-shaped component 22; (ii) the U-shaped component 20 and the second L-shaped component 24; (iii) the first L-shaped component 22 and the base component 12; and (iv) the second L-shaped component 24 and the base component 12 to couple the respective components together. The through-thickness mechanical fastener may extend partially or completely through the thicknesses of the adjoining components. Exemplary through-thickness mechanical fasteners can include stitches, pins, a portion of the component which has been broken off and forced through a thickness of an adjoining component, and combinations thereof. Exemplary techniques for employing mechanical fasteners may including stitching, needlefelting, Z-pins, or similar techniques, or combinations thereof. The stitches may be made of a fabric or polymer material. Exemplary stitches may include Kevlar, nylon, and polyester among other stitch materials used in the aerospace industry. The pins may include carbon composite materials, bare carbon tows and filaments, glass roving and filament, silicon carbide, boron carbide, and metal, among other pin materials used in the aerospace industry. The portion of the component which has been broken off may include materials from the component, such as those discussed below in regard to a ply or ply stack. In some embodiments, not shown in FIG. 3, the adhesive 28 may be continuously or partially disposed between one or more of the U-shaped component 20, the first L-shaped component 22, the second L-shaped component 24, the base component 12 and the fillers 26.

The components of the pi-shaped preform, such as the base component, pair of axially elongated legs, and fillers may each comprise an oriented ply stack. For example, the U-shaped component 20, the first L-shaped component 22, and the second L-shaped component 24 in the axially elongated legs 14, 16 may each comprise an oriented ply stack. Each ply in the oriented ply stack may comprise one or more layers of aligned continuous fibers. Within each layer of the ply, the continuous fibers are oriented in one direction. When a ply includes two or more layers, the continuous fibers of each layer may be oriented in the same direction or different directions relative to the continuous fibers of the other layers in the ply. A ply with multiple layers oriented in different directions could be for economical purposes and/or case of manufacturing.

At least one ply in the oriented ply stack may be held together by stitching fibers. In some embodiments, each ply in the oriented ply stack may be held together by stitching fibers. The stitching fibers are different from the aligned continuous fibers of the ply. For example, the stitching fibers may be a smaller gauge of fiber and/or different material than the aligned continuous fibers of the ply. The stitching fibers may be used to hold the aligned continuous fibers of the ply together. A ply comprising aligned continuous fibers held together by stitching fibers is a non-woven ply. For example, a woven ply has the continuous fibers interwoven to hold the ply together. The plies of the present disclosure, unless otherwise specified, have continuous fibers that are aligned in a single layer or stacked in two or more layers, where the continuous fibers are not interwoven (e.g., nonwoven) among each other. Exemplary stitching fibers may include threads or yarns. Exemplary material for the stitching fibers may include polyester, wool, cotton, acrylic, or other suitable synthetic and/or natural materials.

A ply comprising one or more layers of aligned continuous fibers having stitching fibers holding together the continuous fibers may be commonly called a ‘non-crimp fabric ply’. These plys may be considered a ‘dry’ material. For example, a prepreg ply which includes a resin in an uncured state would be considered a ‘wet’ or ‘sticky’ material.

Some examples of a non-crimp fabric ply include but not limited to unidirectional [0° or 90°], bi-directional [90°/0°], biaxial [±45°], quadriaxial [±45°/90°/0°], triaxial [±45°/0° or 90°/±45°]. Among the advantages of these aligned dry fibers are excellent mechanical performance, and formability and drape-ability for manufacturing of the components of the Pi-shaped preform prior to the resin infusion.

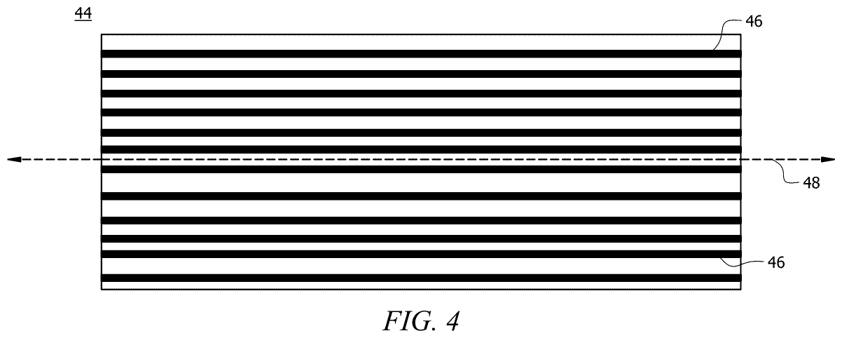

As used herein and depicted in top-down view of an individual single layer ply 44 in FIG. 4, the term “continuous” refers to a fiber 46 that extends the entire length of the ply without a break or breaks in the fiber, or fibers 46 that extend at least 90%, or at least 95%, or at least 99% the length of the ply without a break or breaks in the fiber. The aligned continuous fibers may be selected from, but not limited to, carbon fibers, glass fibers, aramid fibers, graphite fibers, boron fibers, metal fibers, natural/bio fibers, or combinations thereof. In some embodiments, the ply comprises from 30 vol % to 85 vol % of aligned continuous fibers, based on the total weight of the ply. In some embodiments, the ply comprises at least 30 vol % of aligned continuous fibers 46, or at least 35 vol %, at least 40 vol %, at least 45 vol %, at least 50 vol %, at least 55 vol % to less than 60 vol %, less than 65 vol %, less than 70 vol %, less than 75 vol %, less than 80 vol %, or less than 85 vol % of the aligned continuous fibers.

The aligned continuous fibers of the single layer ply 44 may be aligned along a first axis 48. In some embodiments, the aligned continuous fibers 46 may be aligned at an angle of less than about 15 degrees, less than 10 degrees, or less than 5 degrees from the first axis. An individual ply may include a binder material. The binder material may couple the aligned continuous fibers to each other. In some embodiments, the binder material may couple adjacent layers in a ply or plies in the oriented ply stack to each other. Exemplary binder material may include thermoplastic veil, thermoplastic particle, and interleave material. Exemplary binders may include any thermoplastic resin disclosed herein. In some embodiments, the binder material may be present in amount of 0.5 to 10% w/w based on the total weight of the ply. Exemplary aligned continuous fiber ply materials include HiMax® Non-Crimp Unidirectional Fabric and/or HiTape® Unidirectional Tape, available from Hexcel Corporation of Stamford, Connecticut, USA. Exemplary continuous fibers may include HexTow® IM8 carbon fiber, available from Hexcel Corporation.

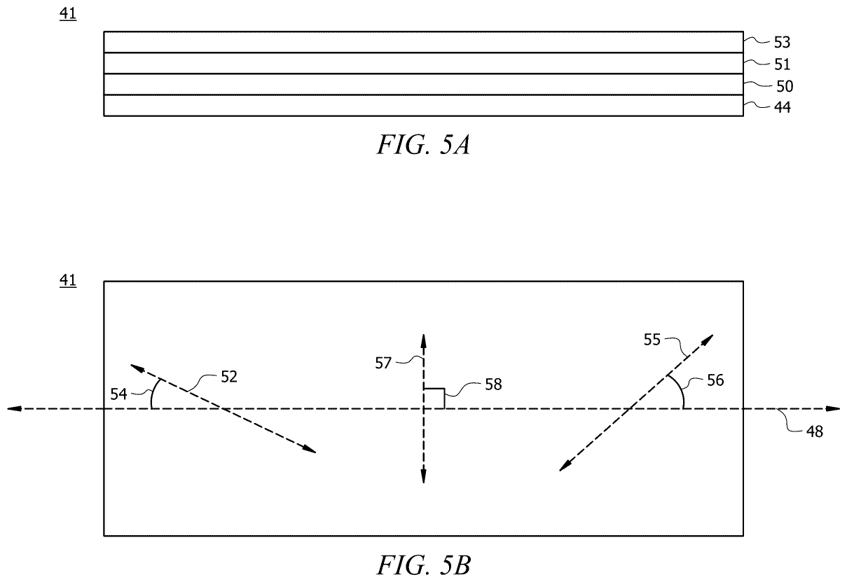

FIG. 5A depicts a side schematic view of an oriented ply stack in accordance with some embodiments. The oriented ply stack 41 includes the single layer ply 44 a second single layer ply 50, a third single layer ply 51, and a fourth single layer ply 53. In some embodiments, an oriented ply stack in this disclosure may include four or more layers of aligned continuous fiber. For example, the four or more layers may be four or more single layer plies as depicted for the ply stack 41. Alternatively, the four or more layers may be one or more multilayer plies, or a combination of single layer plies and multilayer plies. Individual layers of the oriented ply stack may each include aligned continuous fibers aligned to an axis as described herein for single layer ply 44. Each axis may be oriented at an angle with respect to an axis of the other ply in the ply stack. For example, as depicted in FIG. 5B, in a top-down schematic view of the ply stack 41, a second axis 52 of the second single layer ply 50 may be positioned at an angle 54 with respect to the first axis 48. A third axis 55 of the third single layer ply 51 may be positioned at an angle 56 with respect to the first axis 48. A fourth axis 57 of the fourth single layer ply 53 may be positioned at angle 58 with respect to the first axis 48. The first axis 48 may be considered a ‘reference axis’ in that the angles 54, 56, and 58 are defined relative to the first axis 48. The angle between the first axis and the second, third, or fourth axis, or an angle between any of the first through fourth axes, may be any suitable angle. Exemplary angles may include, but are not limited to, angles between 0 degrees to 90 degrees. In some embodiments, angles may include 0 degrees, 5 degrees, 10 degrees, 15 degrees, 30 degrees, 45 degrees, 60 degrees, or 90 degrees.

In some embodiments, the layers of the oriented ply stack are arranged in a sequence within the ply stack. As used herein, the term “sequence” refers to a stack arrangement for the layers of the ply stack that is repeated throughout at least a portion of the ply stack or throughout the entire ply stack. The sequence may be selected based on the desired structural properties of the pi-shaped preform. For example, the layers of aligned continuous fibers in the oriented ply stack for base component 12 may be arranged in a different sequence than those of the axially elongated legs 14, 16 to tailor joint performance.

In some embodiments, the oriented ply stacks for one or more component of the pi-shaped preform may have different numbers of plies or layers of aligned continuous fibers. For example, the number of plies or layers of aligned continuous fibers in an oriented ply stack for the base component 12 may be greater than the number of plies or layers of aligned continuous fibers in an oriented ply stack for the axially elongated legs 14, 16. In some embodiments, the plies of the oriented ply stack may have different thicknesses. For example, to form a component with desirable mechanical properties, one or more plies in the ply stack may have a different thickness than one or more other plies in the ply stack. In some embodiments, the plies of the oriented ply stack may have different dimensions or surface area within a laminate plane. For example, to form a taper for the L-shaped components 22, 24, the plies of the ply stack may have different dimensions to form the taper at the ends of the L-shaped component 22, 24. For example, the plies in the stack for the L-shaped component 22, 24 nearer to the U-shaped component 20 may be larger in dimension than the plies in the stack farther from the U-shaped component 20.

In some embodiments, the ply stack may be quasi-isotropic, approximately equal in all directions within the laminate plane, exemplified by similar plies stacked in a preferred sequence, (45, 0, −45, 90) s, where the numbers are the axes of alignment, and the ‘s’ means symmetric about the center line of the laminate. As discussed herein, an angles and ply sequence may be adjusted to increase or decrease properties in desirable directions, i.e., anisotropic. It is also known that termination of plies, wherein the plies are terminated at certain lengths within an oriented ply stack compared to other plies that cover the full length create local stress concentrations which grow with ply thickness and clustering of these ply drops. To minimize these effects, thickness reductions may be spread as evenly as possible along the length, and through the thickness, by tapering of component thickness to the free edge. In addition, it is preferred to reduce detrimental impacts of the ply drops by using continuous plies to span the discontinuity on both sides, carrying the load symmetrically to other continuous plies.

The components of the pi-shaped preforms 10, 30, 40, such as the base component 12, pair of axially elongated legs 14,16, and fillers 26 may each include an infused resin composition, where the resin composition penetrates and surrounds the oriented ply stacks of the components. The resin composition may have low to moderate viscosity to enable a successful resin infusion, wherein aligned continuous fibers are covered at least 60%, at least 70%, at least 80%, at least 90%, or at least 95% by the resin composition at the end of the resin infusion process. The resin viscosity measured at 40° C. or 104° F. could be at most 100,000 poises, at most 50,000 poises, at most 10,000 poises, or at most 1,000 poises. The minimum resin viscosity could reach at most 100 poises, at most 50 poises, at most 10 poises, or at most 1 poise when measured at a ramp rate of between 0.5 to 5° C./min, wherein a higher ramp rate typically yield a lower minimum resin viscosity. An infusion process for introducing the resin composition to the pi-shaped preforms is described in the methods herein.

The resin composition includes a resin. Exemplary resins may include thermoplastic resins, thermoset resins, and combinations thereof. Suitable thermoplastic resins in the resin composition may include, but are not limited to, polyvinyl formals, polyamides, polycarbonates, polyacetals, polyphenyleneoxides, polyphenylene sulfides, polyarylates, polyesters, polyamideimides, polyimides, polyetherimides, polyimides having phenyltrimethylindane structure, polysulfones, polyethersulfones, polyetherketones, polyetheretherketones, polyaryletherketone, polyaramids, polyethernitriles, polybenzimidazoles, their derivatives or their mixtures thereof. In some embodiments, the thermoplastic resin is a commercial polymer or an oligomer having a lower molecular weight than a commercial polymer.

Thermoset resins may be any resin which can be cured with a curing agent or a cross-linker compound by means of an externally supplied source of energy, such as heat, light, electron beam, or other suitable methods to form a three-dimensional crosslinked network having the required resin modulus. Light energy may include electromagnetic radiation in the microwave and/or ultraviolet wavelength range. Suitable thermoset resins include, but are not limited to, epoxy resins, epoxy novolac resins, ester resins, vinyl ester resins, cyanate ester resins, maleimide resins, bismaleimide resins, bismalcimide-triazine resins, phenolic resins, novolac resins, resorcinolic resins, unsaturated polyester resins, diallylphthalate resins, urea resins, melamine resins, benzoxazine resins, polyimide resins, polyurethanes, their derivatives, or mixtures thereof. In some embodiments, the thermoset resin is a commercial polymer or an oligomer having a lower molecular weight than a commercial polymer.

In some embodiments, the resin composition further includes a hardener. The hardener may be used in a stoichiometric or non-stoichiometric ration relative to a resin. In some embodiments, the hardener may be included in an amount to completely crosslink with a corresponding thermoset resin, i.e., a stoichiometric ratio between the thermoset resin equivalent weight and the hardener equivalent weight. In some embodiments, the hardener may be included in an amount different from a stoichiometric ratio or up to about 75 parts by weight per 100 parts by weight of total thermoset resin (75 phr).

Suitable hardeners include, but are not limited to, polyamides, dicyandiamide [DICY], amidoamines (e.g., aromatic amidoamines such as aminobenzamides, aminobenzanilides, and aminobenzenesulfonamides), aromatic diamines (e.g., diaminodiphenylmetbane, diaminodiphenylsulfone [DDS] such as Aradur® 9664-1 and Aradur® 9719-1 from Huntsman Advanced Materials), aminobenzoates (e.g., trimethylene glycol di-p-aminobenzoate and neopentyl glycol di-p-amino-benzoate), aliphatic amines (e.g., triethylenetetramine, isophoronediamine), cycloaliphatic amines (e.g., isophorone diamine), imidazole derivatives, guanidines such as tetramethylguanidine, anhydrides (e.g., methylhexahydrophthalic anhydride), hydrazides (e.g., adipic acid dihydrazides [ADH], isophthalic dihydrazides [IDH], sebacic acid dihydrazides [SDH], valine dihydrazides [VDH], carbodihydrazides [CDH], icosanedioic acid dihydrazides, phthalic dihydrazide, terephthalic dihydrazide, 1,2,3-benzenetricarboxic trihydrazide, benzoic acid hydrazide, aliphatic monohydrazides, aliphatic trihydrazides, aliphatic tetrahydrazides, and aromatic monohydrazides, aromatic dihydrazides, aromatic trihydrazides, aromatic tetrahydrazides, p-toluenesulfonylhydrazide, benzenesulifinic hydrazide, benzenesulfonyl hydrazide, sulfuryl hydrazide, and phosphoric acid trihydrazide, 2-aminobenzoic hydrazide or 4-aminobenzoic hydrazide), hydrazines (e.g., phenylhydrazine, naphthalene hydrazine, 1-hexylhydrazine, p-phenylenebis(hydrazine), 1,6-hexamethylene dihydrazine, and 1,2-diphenyl hydrazine), phenol-novolac resins and cresol-novolac resins, carboxylic acid amides, polyphenol compounds, polysulfides and mercaptans, and Lewis acids and bases (e.g., boron trifluoride ethylamine, tris-(diethylaminomethyl) phenol), their derivatives, or combinations thereof.

In some embodiments, the resin composition may include a polymer additive. In some embodiments, the resin composition comprises from 0.1% to 40% (w/w) of a polymer additive, based on a total weight of the resin. In some embodiments, the resin includes at least 0.1% (w/w) of the polymer additive, or at least 1%, at least 2%, at least 3%, at least 4%, or at least 5% to less than 10%, less than 11%, less than 12%, less than 13%, less than 14%, or less than 40% (w/w) of the polymer additive, based on the total weight of the resin.

Exemplary polymer additives include thermoplastics, fillers, accelerators, or combinations thereof. Suitable fillers include, but are not limited to, interpenetration network polymers, elastomers, branched polymers, hyperbranched polymers, dendrimers, rubbery polymers, rubbery copolymers, block copolymers, core-shell particles, oxides or inorganic materials such as silica, clay, polyhedral oligomeric silsesquioxanes (POSS), carbonaceous materials (e.g., carbon black, carbon nanotubes, carbon nanofibers, fullerenes), ceramics and silicon carbides, with or without surface modification or functionalization, or combinations thereof.

Suitable accelerators for epoxy resins include, but are not limited to, urea compounds, sulfonate compounds, boron trifluoride piperidine, p-t-butylcatechol, sulfonate compounds, tertiary amines or salts thereof, imidazoles or salts thereof, phosphorus curing accelerators, metal carboxylates, Lewis or Bronsted acids or salts thereof, or combinations thereof.

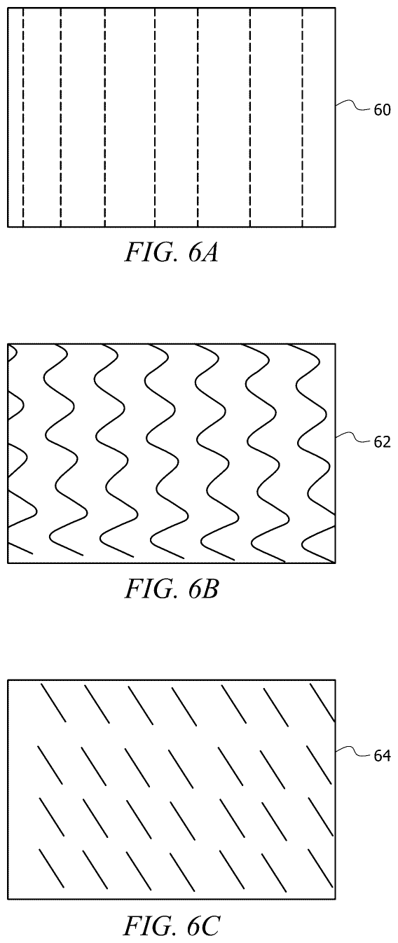

FIGS. 6A to 6C depict top-down views of individual plies or ply stacks in accordance with some embodiments of the disclosure. As shown in the pi-preform 30 of FIG. 3, components of the preform, such as base component 12 and pair of auxiliary legs 14, 16 can be attached together by a through-thickness mechanical fastener 42. The through-thickness mechanical fastener can be utilized in the pi-preform to attached: a component of the pi-preform to another component of the pi-preform, and/or attach the multiple plies together in an oriented ply stack. Some embodiments of patterns used for the mechanical fastener in a ply or ply stack are depicted in FIGS. 6A to 6C. The embodiments of FIG. 6A to 6C may depict embodiments of stitching patterns 60, 62, 64 that may be utilized to reinforce a ply or attach plies to form an oriented ply stack. The stitching fibers disclosed herein may also be present in patterns such as patterns 60, 62, and 64 for individual plies. Similar patterns may be utilized with other techniques, such as Z-pins or needlefelting. Any suitable pattern may be utilized that provides the desired performance to the pi-preform. The mechanical fastener may improve pull off strength, shear strength, and lateral strength in the pi-preform or a joint formed using the pi-preform. Volumes for the mechanical fastener may be lower than the volume of the in-plane continuous fibers. In some embodiments, the volume of the mechanical fastener ranges from 1 to 10 grams per square meter.

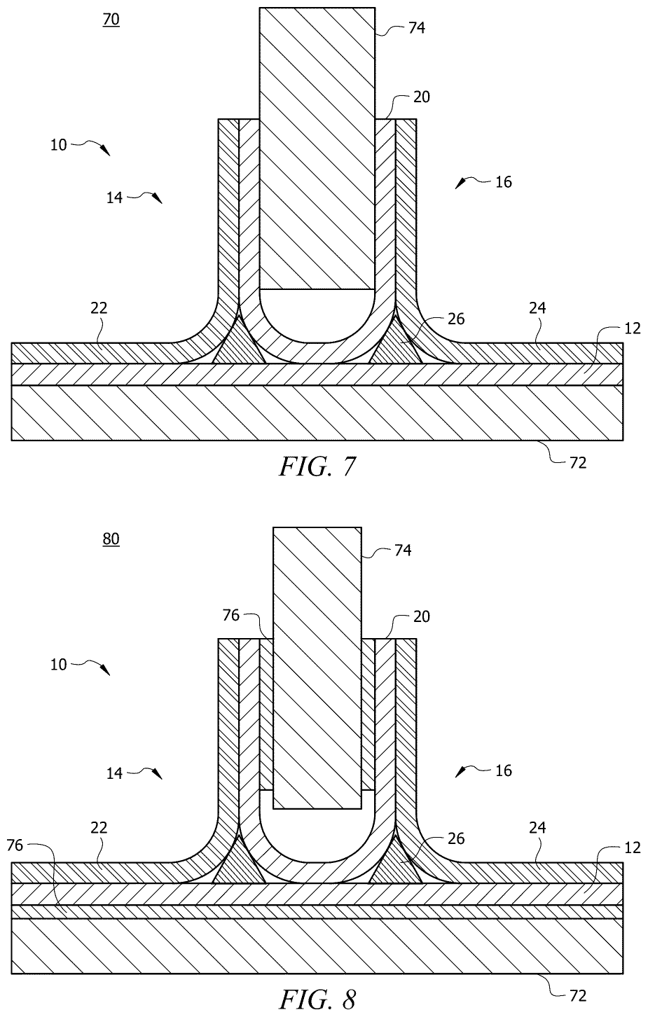

FIG. 7 depicts a pi-joint assembly 70 in accordance with some embodiments of the disclosure. The pi-joint assembly 70 includes the pi-shaped preform 10 having the same components as described in FIG. 1. The pi-shaped preform 10 may be used to join a first joint component 72 to a second joint component 74. In some embodiments the first joint component 72 is a substructure such as a skin of a component of an air, a space, a ground vehicle, a missile, or other platforms and the second joint component 74 is another substructure of the component such as a stiffening structure. In some embodiments, the first joint component 72 is a skin of an aircraft and the second joint component 74 is a web within a substructure of an aircraft. In some embodiments, the first joint component 72 is a spar web within the wing of an aircraft and the second joint component 74 is a rib web within the same wing of the aircraft. In some embodiments, the first and second joint components 72, 74 may comprise metallic or nonmetallic materials. In some embodiments, the first and second joint components may each comprise oriented ply stacks. The oriented ply stack may include aligned continuous fibers. Each ply in the oriented ply stack may include the aligned continuous fibers, wherein the continuous align fibers may be the same or different from those of the pi-preform. The oriented ply stacks may be infused with a resin composition, such as those described herein. The first and second joint components may include the same or different resin compositions, and/or the same or different resin compositions from that of the pi-preform. For example, the resin composition for the first and second joint components may be independently selected based on the function of each joint component.

The first joint component 72 may be coupled to the base component 12 of the pi-shaped preform 10, and the second joint component 74 may be coupled to an inner surface of the channel 18 between the axially elongated legs 14, 16. In some embodiments, no adhesives couple the first joint component 72 to the base component 12 and the second joint component 74 to the axially elongated legs 14, 16 as depicted in FIG. 7. Alternatively, and depicted in FIG. 8 for a pi-joint assembly 80, adhesive 76 may be used to couple the first joint component 72 to the base component 12 and the second joint component 74 to the axially elongated legs 14, 16.

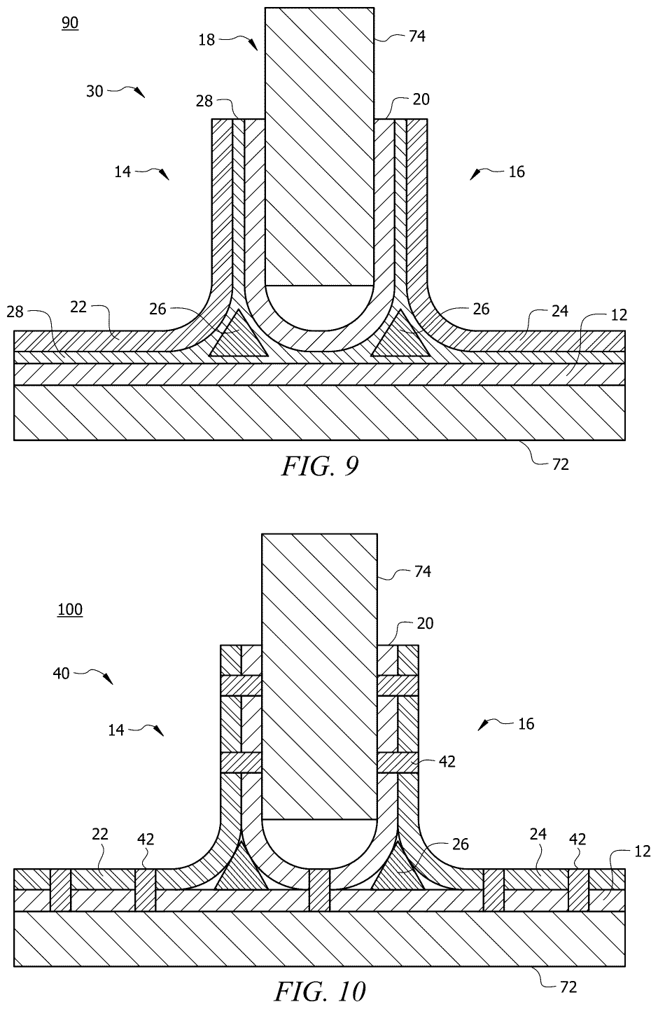

FIGS. 9 to 10 depict embodiments of pi-joint assemblies in accordance with embodiments of the disclosure. FIG. 9 depicts a pi-joint assembly 90 having the pi-preform 30 coupling the first and second joint components 72, 74. FIG. 10 depicts a pi-joint assembly 100 having the pi-preform 40 coupling the first and second joint components 72, 74. In the embodiments depicted in FIGS. 9 to 10, no adhesive is used to couple the first joint component 72 to the base component 12 and the second joint component 74 to the axially elongated legs 14, 16. Alternatively, (not shown in FIGS. 9-10) the adhesive 76 may be present between the first joint component 72 and base component 12 and the second joint component 74 and the axially elongated legs 14, 16.

In FIG. 10, the mechanical fasteners 42 are depicted as attaching components of the pi-preform 40. In some embodiments, (not shown in FIG. 10) the mechanical fasteners 42 may extend into or through the thickness of the first joint component 72 and/or the second joint component 74.

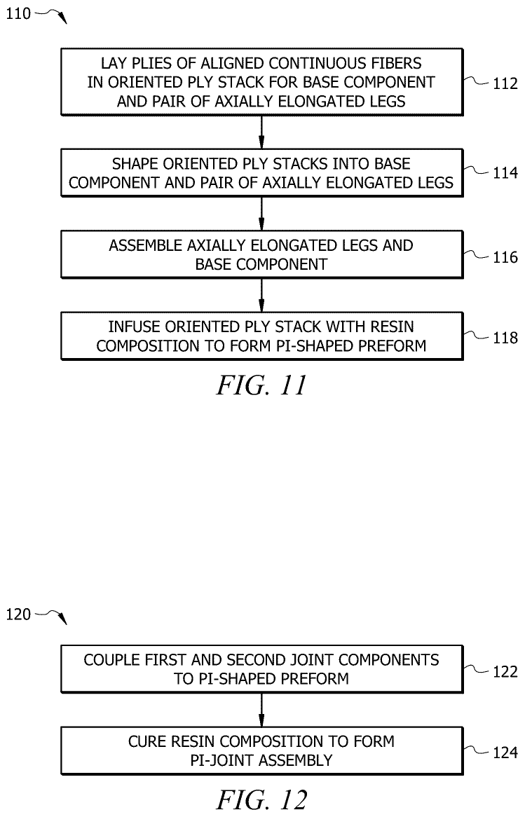

FIG. 11 depicts a method 110 for manufacturing the pi-shaped preforms 10, 30, and 40. The method 110 may begin at operation 112 which includes laying plies of aligned continuous fibers in a ply stack for the base component 12 and the pair of axially elongated legs 14, 16. Laying plies may include laying plies of aligned continuous fibers in a ply stack for fillers 26. In some embodiments, operation 112 may also include laying plies of aligned continuous fibers in a ply stack for the U-shaped component 20, the first L-shaped component 22, and the second L-shaped component 24. In some embodiments, prior to laying plies, individual plies may be modified, for example, by incorporating a through-thickness mechanical fastener 42 as disclosed herein. In some embodiments, after laying plies to form a ply stack, the ply stack may be modified, for example, by incorporating a through thickness mechanical fastener 42 as disclosed herein.

At operation 114, the method 110 includes shaping the ply stacks into the base component 12 and the pair of axially elongated legs 14, 16. Shaping the ply stacks may include shaping the ply stacks into fillers 26. For example, operation 104 may include shaping the ply stacks into the U-shaped component 20, the first L-shaped component 22, and the second L-shaped component 24. Shaping may include thermal forming by heating the ply stacks to a thermal profile suitable to soften the binder material of the plies, making the ply stacks more pliable for shaping. Boundary metallic and non-metallic tooling, such as molded shapes of silicone rubber, polymer, composites, may be used as templates to shape the ply stacks into the desired shape of the base component 12 and the pair of axially elongated legs 14, 16. Operation 114 may further include placing the ply stacks under pressure or vacuum to conform the ply stacks to the shape of the boundary tooling.

At operation 116, the method 110 includes assembling the pair of axially elongated legs 14, 16 and the base component 12 into the shape of the pi-shaped preforms 10, 30, 40. For example, operation 116 may include positioning a filler 26 in a first space between the U-shaped component 20 and the first L-shaped component 22, and a filler 26 in a second space between the U-shaped component 20 and the second L-shaped component 24. In some embodiments, the filler 26 may be assembled concurrently with the elongated legs 14, 16 and the base component 12. Alternatively, in some embodiments, the elongated legs 14, 16 and the base component 12 may be assembled, and then the filler 26 may be inserted into spaces between the elongated legs 14, 16 and the base component 12. Operation 116 may further include coupling the first L-shaped component 22, the U-shaped component 20, the second L-shaped component 24, and the base component 12 into the shape of the pi-shaped preform 10, 30, 40. In some embodiments, the coupling may include thermal bonding of the components, for example, such has heating the components to cause bonding between binder material in adjacent components. For example, pi-preform 10 may be manufacturing using thermal bonding during operation 116. In some embodiments, coupling may include adhesive bonding of the components, for example, such as providing the adhesive 28 between adjacent components to couple the components to each other. In some embodiments, the adhesive 28 may be used in a thin layer, and/or a perforated layer, to minimize the volume of adhesive 28. The adhesive 28 may be providing in this manner to facilitate sufficient infusion of resin in the following operation 118. In some embodiments, the coupling may include using through-thickness mechanical fasteners 42 to couple adjacent components together. For example, pi-preform 40 may be manufactured using mechanical fasteners during operation 116. In some embodiments, for example when using needlefelting during operation 116, an outer ply of the ply stacks of one or more of the components of the pi-preform may be used as a sacrificial layer. In some embodiments, during needlefelting, a sacrificial ply of discontinuous fibers may be applied to the outer surface and used to generate the through-thickness mechanical fastener 42 which is used to couple the one component of the pi-preform 40 to another component.

At operation 118, the assembled pi-preform components are infused with a resin composition to form the pi-preform 10, 30, 40. The infusion process may include infusing a resin composition throughout the ply stacks of the components such that resin is disposed through the thickness of the ply stacks and on the surfaces thereof. Infusion methods may be based on a principle of a pressure difference between resin supply and a vacuum bag or cavity to facilitate flow of the resin composition into the assembled pi-preform component. The vacuum bag or cavity may be part of the tooling. Exemplary infusion methods include vacuum assisted resin transfer molding (VaRTM) (also known as vacuum infusion), resin transfer molding (RTM), resin injection, resin film infusion, double bag vacuum infusion, their derivatives, similar, or alike. VaRTM is a process whereby the resin composition is drawn into the components of the assembled pi-preform, where the assembled pi-preform is held under vacuum against a one-sided rigid mold by a sealed flexible membrane, e.g. a vacuum bag or cavity. An exemplary membrane includes a disposable film (vacuum bag) and this film is sealed against the mold edges using a sealant tape. Additional tooling supports may be used hold components in the assembly in place. For VaRTM, the infusion and cure are typically performed in an oven.

Resin transfer molding (RTM) requires rigid mold halves to withstand the injection pressure that is higher than the ambient pressure. The infusion and cure are typically performed in a press or heating mechanisms such as heating fluid, heating elements attached directly to the rigid mold halves.

Resin film infusion (RFI) is the process whereby the resin composition, in the form of film, is placed directly on the surfaces of the dry preform components in the thickness needed to infuse the preform to the desired resin content levels. Subsequent process steps involving bagging and curing of the part are similar to the VaRTM process but require less time to accomplish infusion of resin into the preform since the resin infusion path is largely reduced to only flowing the resin composition through-the-thickness of the preform.

The resin composition after infusion may be uncured, partially cured, or fully cured.

In some embodiments, fillers can be positioned in spaces formed between the U-shaped component and the L-shaped components prior to resin infusion during assembly of the components, rather than after the assembly is complete.

FIG. 12 depicts a method 120 for manufacturing a pi-joint assembly in accordance with some embodiments of the disclosure. The method 120 begins at operation 122 where the first and second joint components 72, 74 are coupled to the pi-preforms 10, 30, 40. In some embodiments, the first and second joint components 72, 74 may include resin in an uncured, partially cured, or fully cured state and might or might not have the same cure state as the pi-preform. For example, in the absence of adhesive 76, an uncured or partially cured pi-preform may be coupled to an uncured or partially cured first and second joint components. Then at operation 124, the resins of the pi-preform and first and second joint components may be cured to form the pi-joint assembly 70, 80, 90, 100. For example, in the presence of adhesive 76, an uncured, partially cured, or fully cured pi-preform 10, 30, 40 may be coupled to uncured, partially cured, or fully cured first and second joint components 72, 74. Then at operation 124, the resin composition of at least one of the pi-preform, the adhesive, or the first and second joints may be cured to form the pi-joint assembly. Curing the resin composition may be performed by any suitable curing method using an externally supplied source of energy (e.g., heat, light, electron beam, or other suitable methods). Light energy may include electromagnetic radiation in the microwave and/or ultraviolet wavelength range. Suitable cure equipment can include autoclave, oven, press, heated tooling, or press-clave/rapid-clave.

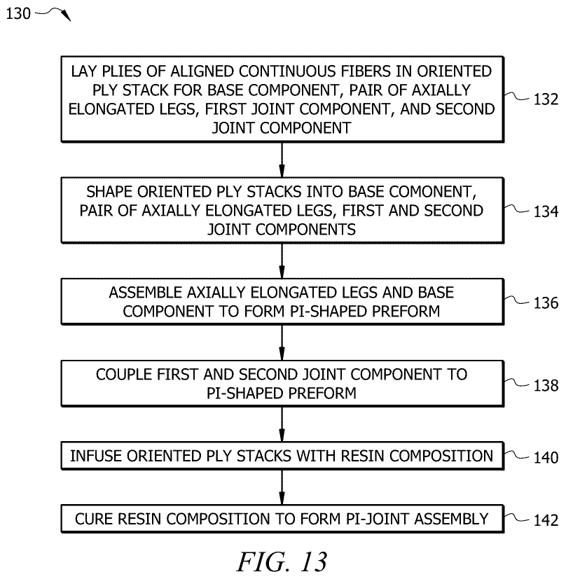

FIG. 13 depicts a method 130 for manufacturing a pi-joint assembly in accordance with some embodiments of the disclosure. Method 130 may be used to manufacture any of pi-joint assemblies 70, 80, 90, 100. Generally, method 130 assembles the entire pi-joint assembly, i.e., pi-preform, first and second joint components, and then infuses resin into the assembled pi-joint assembly. Method 130 may be referred to as a “one-shot infusion” because the entire pi-joint assembly is assembled and then the components of the assembly are infused with resin simultaneously. Exemplary parts having pi-joint assemblies include aircraft wings, fuselages, bulkheads, door surrounds, frames, missile wings, fuselages, housing equipment; rotorcraft blades.

The method 130 begins at operation 132 by laying plies of aligned continuous fibers in ply stacks for the base component 12, axially elongated legs 14, 16, first and second joint components 72, 74. Operation 132 is identical to operation 112 except further includes laying plies in ply stacks for the first and second joint components 72, 74.

At operation 134, the ply stacks may be shaped into the base component 12, axially elongated legs 14, 16, and first and second joint components 72, 74. Operation 132 is identical to operation 114, except further includes shaping the first and second joint components 72, 74.

At operation 136, the base component 12 and axially elongated legs 14, 16 may be assembled in the shape of a pi-preform. Operation 136 is identical to operation 116.

At operation 138, the first and second joint components may be coupled to the assembled pi-preform. Coupling the first and second joint components 72, 74 to the assembled pi-preform may include coupling methods previously discussed, such as thermal heating to coupling via binding material in adjacent components, the use of an adhesive 76, or the use of mechanical fasteners 42 to attach the assembled pi-preform to the first and second joint components 72, 74.

At operation 140, the assembled pi-assembly is infused with a resin composition to infuse the resin composition into and on the surfaces of ply stacks of the assembled components.

At operation 142, the resin composition is cured to form the pi-joint assembly.

In some embodiments, peel ply, surfacing ply, overwrap ply, fabric ply, lightning protection material, or another material can be added, for purposes of case of manufacturing and/or performance improvement, to at least one of the outer most plies of a ply stack, stacks, or an assembly prior to infusion of the resin composition.

In some embodiments, other components can be attached to the surfaces of the first and the second joint components prior to infusion of the resin composition. For example, in a rotorcraft main blade, a counterweight is attached on an inner surface of a skin (e.g., a joint component) and an abrasion strip is attached onto an outer surface of a skin prior to infusion of the resin composition.

In some embodiments, a component of an air, a space, a ground vehicle, a missile, or other platforms include at least of one of the Pi-shape assemblies as described herein. Examples of such components include but not limited to fuselages, wings, bulkheads, empennage, door surrounds, cargo floors, blades, equipment sections.

### Examples

Hereinafter, exemplary embodiments of the present disclosure and comparative examples to the same will be described. The present disclosure is not limited to the exemplary embodiments described below.

### Comparative Example

A three-dimensional woven Pi-preform of Hexcel IM7 carbon fiber infiltrated with 42 w/w (˜0.5 volume fraction fiber (Vff)) Solvay 977-3 epoxy resin was used to co-bond cured web and skin laminates of the same constituents using 3M AF-191 film adhesive into a structural T-panel assembly, vacuum bagged and cured in an autoclave for 6 hours at 355° F. with 92 psi pressure applied. Pull-off and shear test coupons were machined from the T-panel and tested for strength to be used as the baseline.

### Example

A Pi-shaped joint and structural assembly was fabricated via a co-cured, resin transfer molding (RTM) process using a carbon fiber having a tensile modulus of about 300 GPa and tensile strength of about 6000 MPa and a resin composition having a viscosity at 40° C. of about 100 poises and minimum viscosity of about 0.1 poise with a ramp rate of about 2° C./min to yield a 0.51 volume fraction fiber component. The fiber was first converted into 300 gram per square meter areal weight non-crimp fabric (NCF) which is stitched together, including a fusible scrim. The NCF was shaped into ply stacks to match the thickness, shape and overall laminate orientation of the comparative example with tapering and appropriate ply drops. The web and skin panels were also fabricated using NCF to match the properties of the web and skin panels from the comparative example. The U-shaped component, first and second L-shaped components, and fillers were assembled or rolled and thermoformed using the fusible scrim to hold the desired shape. The components were aligned and thermoformed into a sub-assembly. The sub-assembly, a base component, the web and skin panels were assembled in a hard tool, subsequently covered with resin flow media and release films, and then upper shaping tooling was added. The entire tooling was then vacuum bagged with vacuum and resin injection ports. Next, the filled tool has pre-heated, de-volatilized via vacuum and heated resin injected to one end of the assembled part at a controlled rate to maximize wet out before the resin reaches the vacuum port and resin trap. After completing the infiltration and the resin cure at 356° F. for 2 hours, porosity was acceptable and pull off and shear coupons matching the comparative example were machined. Testing of the coupons yielded 91% of the pull-off strength and 179% of the shear strength of the comparative example above. The example averaged higher strength than the comparative example in a lower cost element design and fabrication process.

Embodiments of the present disclosure may include the following:

In some embodiments a pi-shaped preform includes a base component, a pair of axially elongated legs coupled to the base component to define a channel between the axially elongated legs, wherein the base component and the pair of axially elongated legs each comprises an oriented ply stack, wherein each ply in the oriented ply stack comprises aligned continuous fibers, and wherein at least one ply in the oriented ply stack comprises stitching fibers, wherein the stitching fibers hold together the aligned continuous fibers of the at least one ply.

In some embodiments, the pi-shaped preform further comprises fillers positioned in spaces between the based component and the pair of axially elongated legs.

In some embodiments, each ply stack and the fillers comprise a resin composition that is infused to each of the oriented ply stack and the fillers.

In some embodiments, the pair of axially elongated legs include a U-shaped component coupled to a first L-shaped component and a second L-component, the second L-shaped component positioned opposite to the first L-shaped component.

In some embodiments, the fillers comprise a first filler and a second filler, and wherein the first filler is positioned within a first space formed between the U-shaped component and the first L-shaped component, and the second filler is positioned within a second space formed between the U-shaped component and the second L-shaped component.

In some embodiments, there are no additional adhesives disposed between and coupling: (i) the U-shaped component to the first L-shaped component, (ii) the U-shaped component and the second L-shaped component, (iii) the first L-shaped component and the base component, and (iv) the second L-shaped component and the base component.

In some embodiments, each ply in the oriented ply stack comprises one or more layers of aligned continuous fibers.

In some embodiments, the aligned continuous fibers in each of the one or more layers are aligned along an axis, wherein the aligned continuous fibers in each of the one or more layers are aligned at an angle of less than 5 degrees from the axis.

In some embodiments, at least one ply in the oriented ply stack comprises two or more layers, wherein an axis of one of the two or more layers is at a non-zero angle with respect to an axis of another of the two or more layers.

In some embodiments, an axis of a layer of one ply in the oriented ply stack is at a non-zero angle with respect to an axis of a layer in another ply in the oriented ply stack.

In some embodiments, each ply comprises a binder material wherein the binder material couples at least one of the aligned continuous fibers to each other, or at least two plies in the oriented ply stack to each other.

In some embodiments, the aligned continuous fibers are selected from carbon fibers, glass fibers, aramid fibers, graphite fibers, boron fibers, or combinations thereof.

In some embodiments, the pi-shaped preform further comprising a through-thickness mechanical fastener, where the mechanical fastener binds at least one of the plies of the oriented ply stack to each other, or binds the base component to the pair of axial elongated legs.

In some embodiments, the mechanical fastener is selected from the group consisting of stitches, pins, and portions of a ply in the oriented ply stack, wherein the portions extend through the thickness of the oriented ply stack.

In some embodiments, a pi-joint assembly includes the pi-shaped preform, a first joint component coupled to the base component, and a second joint component coupled to an inner surface of the channel between the axially elongated legs.

In some embodiments, a pi-joint assembly further includes one or more adhesives, wherein the one or more adhesives couple: (i) the first joint component to the base component; and (ii) the second joint component to the axially elongated legs.

In some embodiments, the first and second joint component each comprises an oriented ply stack, wherein each ply in the oriented ply stack comprises aligned continuous fibers, and wherein each ply stack comprises a resin composition and aligned continuous fibers.

In some embodiments, the resin composition of the first and second joint components is different from the resin composition of the pi-preform.

In some embodiments, a pi-joint assembly includes a base component, a pair of axially elongated legs coupled to the base component to define a channel between the axially elongated legs, a first joint component coupled to the base component, and a second joint component coupled to an inner surface of the channel between the axially elongated legs, wherein the base component, the pair of axially elongated legs, the first joint component and the second joint component each comprises an oriented ply stack, where each ply in the oriented ply stack comprises aligned continuous fibers, and wherein at least one ply in the oriented ply stack comprises stitching fibers, wherein the stitching fibers hold together the aligned continuous fibers of the at least one ply.

In some embodiments, a pi-joint assembly further includes fillers positioned in spaces between the based component and the pair of axially elongated legs

In some embodiments, each ply stack and the fillers comprise a resin composition that is infused to each of the oriented ply stack and the fillers.

In some embodiments, there are no additional adhesives disposed between and coupling: (i) the first joint component to the base component; and (ii) the second joint component to the axially elongated legs.

In some embodiments, a pi-joint assembly further includes a through-thickness mechanical fastener, where the mechanical fastener binds at least one of the plies of the oriented ply stack to each other, binds the base component to the pair of axial elongated legs, binds the first joint component to the base component, or binds the second joint component to the pair of axially elongated legs.

In some embodiments, a method of manufacturing a pi-shaped preform includes laying plies in an oriented ply stack for a base component and a pair of axially elongated legs, wherein each ply comprises aligned continuous fibers, shaping each of the oriented ply stacks into the base component and the pair of axially elongated legs, assembling the pair of axially elongated legs to the base component to form the pi-shaped preform, the pi-shaped preform having a channel defined between the axially elongated legs, infusing a resin into the ply stacks, and curing the resin to a desired state of cure after infusion.

In some embodiments, at least one ply in the oriented ply stack comprises stitching fibers, wherein the stitching fibers hold together the aligned continuous fibers of the at least one ply. In some embodiments, shaping the pair of axially elongated legs further includes shaping the oriented ply stack into a U-shaped component, a first L-shaped component, and a second L-shaped component, wherein the pair of axially elongated legs comprise the U-shaped component, the first L-shaped component, and the second L-shaped component.

In some embodiments, the method further includes positioning a first filler in a first space between the U-shaped component and the first L-shaped component, and a second filler in a second space between the U-shaped component the second L-shaped component.

In some embodiments, assembling the pair of elongated legs to the base component further includes inserting an adhesive positioned between (i) the U-shaped component and the first L-shaped component; (ii) the U-shaped component and the second L-shaped component; (iii) the first L-shaped component and the base component; and (iv) the second L-shaped component and the base component.

In some embodiments, assembling the pair of elongated legs to the base component further includes coupling at least one of the following via a mechanical fastener: (i) the first L-shaped component to the U-shaped component, (ii) the second L-shaped component to the U-shaped component, (iii) at least one of the first L-shaped component, the U-shaped component, or the second L-shaped component to the base component.

In some embodiments, the mechanical fastener is coupled using one selected from the group consisting of stitching, needlefelting, Z-pins, and combinations thereof.

In some embodiments, laying plies further includes coupling the plies of the oriented ply stack to each other via a mechanical fastener component.

In some embodiments, each ply in the oriented ply stack comprises one or more layers of aligned continuous fibers.

In some embodiments, the aligned continuous fibers in each of the one or more layers are aligned along an axis, wherein the aligned continuous fibers in each of the one or more layers are aligned at an angle of less than 5 degrees from the axis.

In some embodiments, at least one ply in the oriented ply stack comprises two or more layers, wherein an axis of one of the two or more layers is at a non-zero angle with respect to an axis of another of the two or more layers.

In some embodiments, an axis of a layer of one ply in the oriented ply stack is at a non-zero angle with respect to an axis of a layer in another ply in the oriented ply stack.

In some embodiments, each ply comprises a binder material wherein the binder material couples at least one of the aligned continuous fibers to each other, or at least two plies in the oriented ply stack to each other.

In some embodiments, the aligned continuous fibers are selected from carbon fibers, glass fibers, aramid fibers, graphite fibers, boron fibers, or combinations thereof.

In some embodiments, a method of manufacturing a pi-joint assembly includes, after infusion of the resin composition to form the pi-shaped preform, the resin composition being in a partially cured state, coupling a first joint component to the base component, and coupling a second joint component to an inner surface of the channel between the axially elongated legs, and curing the pi-joint assembly.

In some embodiments, coupling the first and second joint components further comprises coupling the first joint component to the base component via one or more adhesives, and coupling the second joint component to the inner surface of the channel between the axially elongated legs via one or more adhesives.

In some embodiments, a method of manufacturing a pi-joint assembly includes laying plies in an oriented ply stack for a base component, a pair of axially elongated legs, a first joint component and a second joint component, wherein each ply comprises of aligned continuous fibers, shaping each of the oriented ply stacks into the base component, the pair of axially elongated legs, the first and second joint component, assembling the pair of axially elongated legs to the base component to form the pi-shaped preform, the pi-shaped preform having a channel defined between the axially elongated legs, coupling the first joint component to the base component, coupling the second joint component to an inner surface of the channel between the axially elongated legs, infusing a resin composition into the oriented ply stacks, and curing the pi-joint assembly.

In some embodiments, at least one ply in the oriented ply stack comprises stitching fibers, wherein the stitching fibers hold together the aligned continuous fibers of the at least one ply;

In some embodiments, shaping the pair of axially elongated legs further includes shaping the oriented ply stack into a U-shaped component, a first L-shaped component, and a second L-shaped component, wherein the pair of axially elongated legs comprise the U-shaped component, the first L-shaped component, and the second L-shaped component.

In some embodiments, the method further includes positioning a first filler in a first space between the U-shaped component and the first L-shaped component, and a second filler in a second space between the U-shaped component the second L-shaped component.

In some embodiments, assembling the pair of elongated legs to the base component further includes coupling at least one of the following via a mechanical fastener: (i) the first L-shaped component to the U-shaped component, (ii) the second L-shaped component to the U-shaped component, (iii) at least one of the first L-shaped component, the U-shaped component, or the second L-shaped component to the base component.

In some embodiments, the mechanical fastener is coupled using one selected from the group consisting of stitching, needlefelting, Z-pins, and combinations thereof. In some embodiments, laying plies further includes coupling the plies of the oriented ply stack to each other via a mechanical fastener component.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A pi-shaped preform, comprising:
a base component;
a pair of axially elongated legs coupled to the base component to define a channel between the axially elongated legs; and
wherein the base component and the pair of axially elongated legs each comprises an oriented ply stack, wherein each ply in the oriented ply stack comprises aligned continuous fibers, and wherein at least one ply in the oriented ply stack comprises stitching fibers, wherein the stitching fibers hold together the aligned continuous fibers of the at least one ply.

2. The pi-shaped preform of claim 1, further comprises fillers positioned in spaces between the based component and the pair of axially elongated legs.

3. The pi-shaped preform of claim 2, each ply stack and the fillers comprise a resin composition that is infused to each of the oriented ply stack and the fillers.

4. The pi-shaped preform of claim 3, wherein the pair of axially elongated legs include a U-shaped component coupled to a first L-shaped component and a second L-component, the second L-shaped component positioned opposite to the first L-shaped component.

5. The pi-shaped preform of claim 4, wherein the fillers comprise a first filler and a second filler, and wherein the first filler is positioned within a first space formed between the U-shaped component and the first L-shaped component, and
wherein the second filler is positioned within a second space formed between the U-shaped component and the second L-shaped component.

6. The pi-shaped preform of claim 5, wherein there are no additional adhesives disposed between and coupling:
(i) the U-shaped component to the first L-shaped component;
(ii) the U-shaped component and the second L-shaped component;
(iii) the first L-shaped component and the base component; and
(iv) the second L-shaped component and the base component.

7. The pi-shaped preform of claim 1, wherein each ply in the oriented ply stack comprises one or more layers of aligned continuous fibers.

8. The pi-shaped preform of claim 7, wherein the aligned continuous fibers in each of the one or more layers are aligned along an axis, wherein the aligned continuous fibers in each of the one or more layers are aligned at an angle of less than 5 degrees from the axis.

9. The pi-shaped preform of claim 8, wherein at least one ply in the oriented ply stack comprises two or more layers, wherein an axis of one of the two or more layers is at a non-zero angle with respect to an axis of another of the two or more layers.

10. The pi-shaped preform of claim 8, wherein an axis of a layer of one ply in the oriented ply stack is at a non-zero angle with respect to an axis of a layer in another ply in the oriented ply stack.

11. The pi-shaped preform of claim 1, wherein each ply comprises a binder material wherein the binder material couples at least one of the aligned continuous fibers to each other, or at least two plies in the oriented ply stack to each other.

12. The pi-shaped preform of claim 1, wherein the aligned continuous fibers are selected from carbon fibers, glass fibers, aramid fibers, graphite fibers, boron fibers, or combinations thereof.

13. The pi-shaped preform of claim 1, further comprising a through-thickness mechanical fastener, where the mechanical fastener binds at least one of the plies of the oriented ply stack to each other, or binds the base component to the pair of axial elongated legs.

14. The pi-shaped preform of claim 13, where the mechanical fastener is selected from the group consisting of stitches, pins, and portions of a ply in the oriented ply stack, wherein the portions extend through the thickness of the oriented ply stack.

15. A pi-joint assembly, comprising:
the pi-shaped preform of claim 3;
a first joint component coupled to the base component; and
a second joint component coupled to an inner surface of the channel between the axially elongated legs.

16. The pi-joint assembly of claim 15, where the first and second joint component each comprises an oriented ply stack, wherein each ply in the oriented ply stack comprises aligned continuous fibers, and wherein each ply stack comprises a resin composition and aligned continuous fibers.

17. A pi-joint assembly, comprising:
a base component;
a pair of axially elongated legs coupled to the base component to define a channel between the axially elongated legs;
a first joint component coupled to the base component; and
a second joint component coupled to an inner surface of the channel between the axially elongated legs,
wherein the base component, the pair of axially elongated legs, the first joint component and the second joint component each comprises an oriented ply stack, where each ply in the oriented ply stack comprises aligned continuous fibers, and wherein at least one ply in the oriented ply stack comprises stitching fibers, wherein the stitching fibers hold together the aligned continuous fibers of the at least one ply.

18. A pi-joint assembly of claim 17, further comprises fillers positioned in spaces between the based component and the pair of axially elongated legs

19. A pi-joint assembly of claim 18, wherein each ply stack and the fillers comprise a resin composition that is infused to each of the oriented ply stack and the fillers.

20. The pi-joint assembly of claim 19, further comprising a through-thickness mechanical fastener, where the mechanical fastener binds at least one of the plies of the oriented ply stack to each other, binds the base component to the pair of axial elongated legs, binds the first joint component to the base component, or binds the second joint component to the pair of axially elongated legs.
